(19) United States
(12) Patent Application Publication
(10) Pub. No.: US 2016/0046101 A1
(43) Pub. Date: Feb. 18, 2016

(54) IN-MOLD LABEL AND LABELED PLASTIC CONTAINER USING SAME

(71) Applicant: YUPO CORPORATION, Tokyo (JP)

(72) Inventors: Takahiko UEDA, Ibaraki (JP); Yuuichi IWASE, Ibaraki (JP)

(73) Assignee: YUPO CORPORATION, Tokyo (JP)

(21) Appl. No.: 14/779,056

(22) PCT Filed: Mar. 25, 2014
(86) PCT No.: PCT/CN2014/074024

§ 371 Date: Sep. 22, 2015

(30) Foreign Application Priority Data
Mar. 28, 2013 (JP) 201310105575.5

(51) Int. Cl. B32B 27/08; C09J 7/02; B65D 25/20

(52) U.S. Cl. CPC B32B 27/08; B65D 25/205; C09J 7/0246; B32B 2519/00; B32B 2307/31

(57) ABSTRACT

An in-mold label having a heat sealing layer formed on one surface of an olefinic resin film, wherein the heat sealing layer contains a thermoplastic resin satisfying (1) at least one crystallization peak occurs between 85 to 110° C. in differential scanning calorimetry and (2) the hot tack force at 130° C. is 120 to 350 gf/cm², can reduce defects in a labeled container even when the container is produced in a short cycle time.

### TECHNICAL FIELD

The present invention relates to in-mold labels.

The invention particularly relates to in-mold labels that do not undergo deformation such as detachment and blisters during the production of labeled plastic containers in which an in-mold label is attached to a container in the process of forming the container inside a mold, and that can reduce defects in the product containers even when containers are produced in a short cycle time. The invention also relates to stable quality labeled plastic containers that can be efficiently produced with the use of the in-mold labels.

### BACKGROUND ART

Plastic containers of various sizes and shapes have been used to contain, distribute, display, sell, store, and use a wide variety of liquids (for example, cooking oils, liquid seasonings, drinks, alcoholic beverages, kitchen detergents, laundry detergents, shampoos, hairstyling agents, liquid soaps, sanitizing alcohol, car oils, car shampoos, agrichemicals, pesticides, and herbicides).

Such plastic containers are typically produced as products with a single layer or multiple layers of resin such as polyethylene, polypropylene, polyester, and polyamide, using blow molding or other techniques.

Plastic containers also have labels showing product names or other such information to specify the contents of the containers. Many labels are paper materials backed by a pressure sensitive adhesive, or heat-shrinkable films, and are applied to the product plastic containers. Labels also may be applied while forming the plastic containers.

In-mold labeling is a process in which a label placed within a mold is applied to a plastic container while forming the container inside the mold. This process does not require attaching labels to the molded containers, or storing the molded products after labeling process. This is advantageous in terms of laborsaving and saving the space needed for the storage of goods after labeling process, and allowing the products to be shipped in no time.

In-mold labeling and in-mold labels for use in in-mold labeling are described in many literatures. For example, Roster et al. in Germany disclosed in 1969 using an in-mold label reverse printed on a transparent plastic film, and attaching the in-mold label to a plastic container using in-mold labeling (Patent Literature 1). In 1989, Dudley in the United States disclosed an in-mold label that comprises a coextruded plastic film containing a heat activatable ethylene copolymer adhesive layer (Patent Literature 2).

Yasuda in 1989 disclosed an in-mold label with an embossed heat sealing resin layer (Patent Literature 3). Ohno in 1997 disclosed an in-mold label with a heat sealing resin layer of primarily an ethylene-α-olefin copolymer obtained through copolymerization of 40 to 98 weight % of ethylene and 60 to 2 weight % of α-olefin of 3 to 30 carbon atoms in the presence of a metallocene catalyst (Patent Literature 4).

### CITATION LIST

### Patent Literatures

Patent Literature 1: German Patent No. 1,807,766
Patent Literature 2: U.S. Pat. No. 4,837,075
Patent Literature 3: JP-UM-A-1-105960
Patent Literature 4: JP-A-9-207166

### SUMMARY OF INVENTION

### Technical Problem

As described above, in-mold labeling enables a label to be simultaneously attached while forming a plastic container, and this is advantageous in terms of improving productivity.

Many of the in-mold labels currently available, including that described in Patent Literature 4, use low-melting-point thermoplastic resins for the heat sealing layer to adapt to a wide range of forming conditions, particularly to enable sufficient activation and heat sealing even when the container resin has a low melt extrusion temperature.

However, in-mold labels using low-melting-point thermoplastic resins for the heat sealing resin layer often fail to provide sufficient adhesion, and form blisters (swelling) when the labeled plastic container is discharged from the mold in high temperature (specifically, in a temperature state higher than the melting peak temperature of the thermoplastic resin). This requires the labeled plastic container to be discharged after being sufficiently cooled inside the mold, and lowering the mold cooling temperature to improve the cooling effect, or increasing the production cycle time to afford a longer cooling time. In order to achieve a low mold cooling temperature, it is technically possible to cool the mold below the freezing point by upgrading the cooling equipment and using an antifreeze for the cooling medium.

This, however, involves the risk of causing adverse effects on the stable forming of plastic containers in the event when condensation occurs on mold surfaces under low mold cooling temperatures, particularly in high-temperature and high-humidity low latitude regions, where plastic container production bases are concentrated these days. It is therefore typically necessary in these regions to use mild cooling conditions that do not cause condensation, and to increase the production cycle time instead.

However, such a lengthy production cycle time works against the high productivity originally offered by in-mold labeling. There is also an increasing demand in these high-temperature and high-humidity production bases to reduce production cycle time for improved productivity. There accordingly is a need for an in-mold label that can be used to produce stable quality plastic containers without generating defects such as blisters even when plastic containers are discharged from the mold under high-temperature conditions (hereinafter, “high-temperature discharge”).

### Solution to Problem

The present inventors conducted intensive studies, and thought that, in order to solve the foregoing problems, it would be necessary to control the crystallization behavior of the thermoplastic resin forming the heat sealing layer of an in-mold label if the in-mold label were to be used under manufacturing conditions that involve high-temperature discharge of the container resin. Specifically, it was found that the label reliably attaches to a plastic container, and the thermoplastic resin before crystallization maintains a sufficient tack force (hot tack force) even in a molten state when the thermoplastic resin forming the heat sealing layer of the in-mold label has a crystallization temperature (crystallization peak temperature) that is equal to or greater than a certain specific temperature, and immediately crystallizes (solidifies) even in a relatively high temperature range. The tack force was found to be strong enough to ensure the bonding between the label and the plastic container during the high-temperature discharge, and in-mold labeling of the plastic container was possible with the in-mold label without causing defects such as blisters even when the cooling time was reduced in the manufacture of the in-mold labeled plastic container. The present invention was completed on the basis of these findings.

Specifically, the present invention is concerned with the in-mold labels having the following configurations [1] to [7], and with the labeled plastic container set forth in [8] below.

[1] An in-mold label comprising a heat sealing layer formed on one surface of an olefinic resin film, wherein the heat sealing layer contains a thermoplastic resin having the following characteristics (1) and (2):

(1) at least one crystallization peak occurs between 85 to 110° C. in differential scanning calorimetry,
(2) the hot tack force at 130° C. is 120 to 350 gf/cm².

[2] The in-mold label according to [1], wherein the thermoplastic resin contained in the heat sealing layer has at least one melting peak between 90 to 130° C. in differential scanning calorimetry.

[3] The in-mold label according to [1] or [2], wherein the thermoplastic resin contained in the heat sealing layer is an ethylene-α-olefin copolymer copolymerized with a metallocene catalyst.

[4] The in-mold label according to [3], wherein the thermoplastic resin contained in the heat sealing layer is an ethylene-1-hexene copolymer copolymerized with a metallocene catalyst by a vapor phase method.

[5] The in-mold label according to any one of [1] to [4], wherein the thermoplastic resin contained in the heat sealing layer has a density of 0.905 to 0.940 g/cm³.

[6] The in-mold label according to any one of [1] to [5], wherein the olefinic resin film contains an olefinic resin and 1 to 75 weight % of an inorganic fine powder.

[7] The in-mold label according to any one of [1] to [6], wherein the olefinic resin film is stretched in at least one direction.

[8] A labeled plastic container comprising the in-mold label of any one of [1] to [7] attached thereto.

### Advantageous Effects of Invention

The present invention improves an hourly yield of in-mold labeled plastic containers in manufacture of containers, and can reduce defects such as blisters in the products even when the cooling time is reduced to reduce the production cycle time. The invention can thus improve yield and production efficiency.

### BRIEF DESCRIPTION OF DRAWINGS

FIG. 1 shows a state of blisters.

FIG. 2 shows an orange skin-like state an enlarged view; a, the appearance of a label upon discharge in Example 3; b, the appearance of a label upon discharge in Example 1; c, the appearance of a label upon discharge in Example 2.

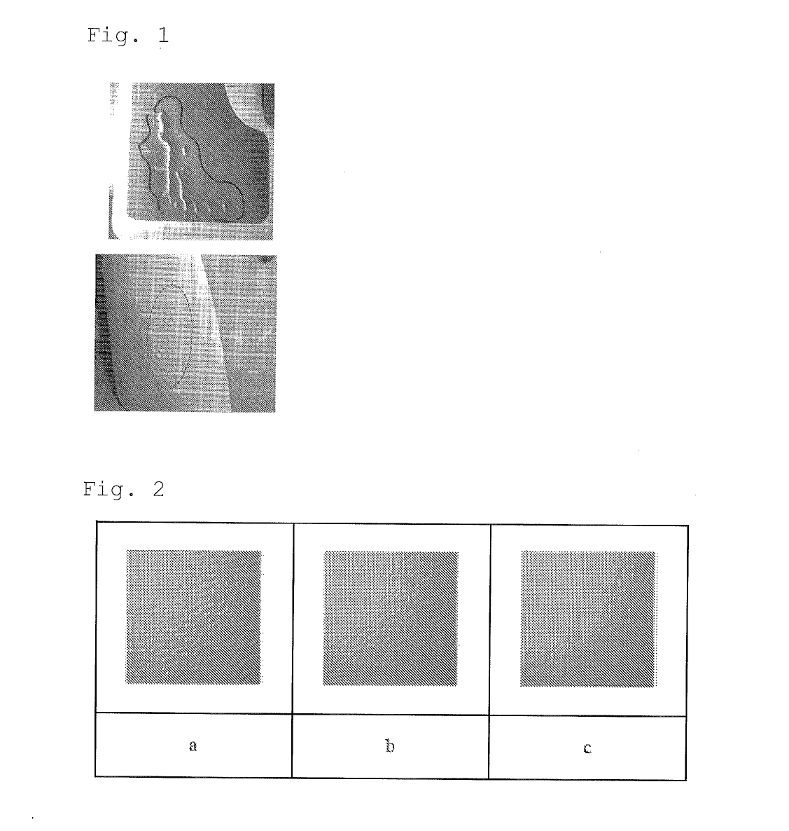

### DESCRIPTION OF EMBODIMENTS

The present invention is described by way of embodiments. The embodiments below are not intended to limit the invention set forth in the patent claims below. It should also be noted that not all combinations of the features described in the embodiments are necessarily required to provide solutions to the problems to be solved by the invention. As used herein, the numerical ranges expressed as intervals from one value to another are intended to include the endpoints as lower and upper limits.

### [In-Mold Label]

The in-mold label of the present invention includes a heat sealing layer that contains a thermoplastic resin and is formed on one surface of an olefinic resin film.

### [Olefinic Resin Film]

The olefinic resin film becomes the base of the heat sealing layer (described later) in the in-mold label. The olefinic resin film also confers properties such as mechanical strength and rigidity to the in-mold label to provide the stiffness needed for printing or insertion of the label into a mold, and water resistance, chemical resistance, and, as required, other properties such as printability, opacity, and lightness. The following specifically describes the composition, the configuration, and the producing process of the olefinic resin film.

### [Olefinic Resin]

Examples of the olefinic resin used for the olefinic resin film include polyolefinic resins such as high-density polyethylene, medium-density polyethylene, low-density polyethylene, propylene-based resin, poly-4-methyl-1-pentene, and ethylene-cyclic olefin copolymer. Other examples include homopolymers of olefins such as ethylene, propylene, butylene, hexene, octene, butadiene, isoprene, chloroprene, and methyl-1-pentene, and copolymers of two or more of these olefins. Yet other examples includes functional group-containing olefinic resins such as ethylene-vinyl acetate copolymer, ethylene-acrylic acid copolymer, ethylene-methacrylic acid copolymer, metal salts of ethylene-methacrylic acid copolymer (ionomer), ethylene-alkyl acrylate copolymer, ethylene-alkyl methacrylate copolymer (the alkyl group has preferably 1 to 8 carbon atoms), maleic acid modified-polyethylene, and maleic acid modified-polypropylene.

Preferred as the olefinic resin from the viewpoints of film formability, moisture-proof property, mechanical strength, and cost are propylene-based resins.

Examples of the propylene-based resins include isotactic, syndiotactic, and various other tactic homopolypropylene formed through homopolymerization of propylene. Other examples include propylene-based copolymers of various tacticities formed through copolymerization the main constituent propylene with α-olefins such as ethylene, 1-butene, 1-hexene, 1-heptene, 1-octene, and 4-methyl-1-pentene. The propylene-based copolymers may be binary, ternary, or higher copolymers, and may be random copolymers or block copolymers.

The olefinic resin used for the olefinic resin film may be one or more olefinic resins selected from the foregoing olefinic resins, and these may be used either alone or in combination. For example, a homopolypropylene may be used as a mixture with 2 to 25 weight % of a resin having a lower melting point than the homopolypropylene. Examples of such low-melting-point resins include high-density to low-density polyethylenes.

The olefinic resin film of the present invention may contain components other than the olefinic resin. For example, the olefinic resin film may contain at least one of an inorganic fine powder and an organic filler. With components such as an inorganic fine powder, the olefinic resin film can be provided as a white or opaque film, and can improve the visibility of the print on the in-mold label. When stretched, the olefinic resin film containing an inorganic fine powder or the like can form large numbers of fine voids that originate from the inorganic fine powder inside the film. Such voids can further provide whiteness, opacity, and lightness to the film.

### [Inorganic Fine Powder]

The inorganic fine powder is not particularly limited, as long as it can make the olefinic resin film white or opaque. Specific examples of the inorganic fine powder include heavy calcium carbonate, light calcium carbonate, baked clay, talc, diatomaceous earth, white clay, barium sulfate, magnesium oxide, zinc oxide, titanium oxide, barium titanate, silica, alumina, zeolite, mica, sericite, bentonite, sepiolite, vermiculite, dolomite, wollastonite, and glass fiber. The inorganic fine powder also may be one obtained after surface treatment of these with materials such as fatty acids, polymer surfactants, and antistatic agents and the like. Particularly preferred are heavy calcium carbonate, light calcium carbonate, baked clay, and talc for their desirable property to form voids, and low cost. Titanium oxide is preferred from the viewpoint of whiteness and opacity.

### [Organic Filler]

The organic filler is not particularly limited, as long as it can make the olefinic resin film white or opaque. Preferably, the organic filler is immiscible with the olefinic resin, has a higher melting point or glass transition point than the olefinic resin, and finely disperses under the melt knead conditions of the olefinic resin. Specific examples of the organic filler include polyethylene terephthalate, polybutylene terephthalate, polyethylene naphthalate, polystyrene, polyamide, polycarbonate, nylon-6, nylon-6,6, cyclic polyolefin, polystyrene, polymethacrylate, polyethylene sulfide, polyphenylene sulfide, polyimide, polyether ketone, polyether ether ketone, polymethylmethacrylate, poly-4-methyl-1-pentene, homopolymers of cyclic olefin, and copolymers of cyclic olefin and ethylene. It is also possible to use a fine powder of thermosetting resin such as melamine resin.

The inorganic fine powder and the organic filler may be one or more selected from the foregoing examples, and these may be used either alone or in combination. When used in a combination of two or more, the combination may be a combination of inorganic fine powder and organic filler.

The average particle size of the inorganic fine powder, and the average dispersed particle size of the organic filler are preferably 0.01 μm or more, more preferably 0.1 μm or more, further preferably 0.5 μm or more. The average particle size or average dispersed particle size is preferably 0.01 μm or more from the viewpoints of ease of mixing with the thermoplastic resin, and ease of void formation. The average particle size of the inorganic fine powder, and the average dispersed particle size of the organic filler usable in the present invention are preferably 30 μm or less, more preferably 15 μm or less, further preferably 5 μm or less. The average particle size or average dispersed particle size is preferably 30 μm or less so that the film, when stretched to create voids and improve opacity or printability, does not cause troubles such as sheet breakage during the stretch, and deterioration of surface layer strength.

As an example, the particle size of the inorganic fine powder usable in the present invention may be measured as the particle diameter at 50% in the cumulative distribution (cumulative 50% particle size), using a particle measurement device, for example, the laser diffraction particle measurement device Microtrack available from NIKKISO CO., Ltd. The particle size of the organic filler dispersed in the thermoplastic resin by being melt kneaded and dispersed may also be determined as a mean value of at least 10 maximum particle diameters in a cross section of the thermoplastic resin film observed under an electron microscope.

In the present invention, when the olefinic resin film contains at least one of the inorganic fine powder and the organic filler, the content of the inorganic fine powder and the organic filler in the olefinic resin film is preferably 1 weight % or more, more preferably 5 weight % or more, particularly preferably 10 weight % or more. When contained in 1% or more, the inorganic fine powder and the organic filler can more easily provide whiteness and opacity to the olefinic resin film. On the other hand, the content of the inorganic fine powder and the organic filler in the olefinic resin film is preferably 75 weight % or less, more preferably 40 weight % or less, particularly preferably 30 weight % or less. With the inorganic fine powder and the organic filler contained in 75 weight % or less, the olefinic resin film can be more stably formed.

### [Additional Components]

Any known additive may be added to the olefinic resin film, as required. Examples of such additives include antioxidants, light stabilizers, UV absorbers, inorganic fine powder dispersants, lubricants such as higher fatty acid metal salts, anti-blocking agents such as higher fatty acid amides, dyes, pigments, plasticizers, nucleating agents, release agents, and fire retardants.

When adding an antioxidant, it is possible to use, for example, a sterically hindered phenol-based antioxidant, a phosphorus-based antioxidant, or an amine-based antioxidant in typically 0.001 to 1 weight %. When using a light stabilizer, it is possible to use, for example, a sterically hindered amine-based light stabilizer, a benzotriazole-based light stabilizer, or a benzophenone-based light stabilizer in typically 0.001 to 1 weight %. Dispersants and lubricants are used to, for example, disperse the inorganic fine powder. Specifically, it is possible to use a silane coupling agent, higher fatty acids such as oleic acid and stearic acid, a metal soap, polyacrylic acid, polymethacrylic acid, or salts thereof in typically 0.01 to 4 weight %. Preferably, these are added within a range that does not interfere with the printability and the heat sealing property of the in-mold label.

### [Configuration of Olefinic Resin Film]

The olefinic resin film as a label base is obtained by depositing an olefinic resin and forming a desired olefinic resin film. The olefinic resin film may be obtained by depositing an olefinic resin after desirably mixing it with other components such as the inorganic fine powder, the organic filler, and known additives.

The olefinic resin film may have a monolayer structure or a multilayer structure.

The preferred form of the olefinic resin film for use as a support of a label in the present invention is a multilayer structure, with layers of unique properties. For example, the olefinic resin film may have a three-layer structure of a surface layer, a base layer, and a surface layer, with the desirable rigidity, opacity, or lightness for the in-mold label conferred to the base layer, and with one of the surface layers having a surface structure desirable for printing, and the other surface layer having a surface structure that is desirable for providing the heat sealing layer. In this way, a printable paper preferable for use as the in-mold label can be obtained. By appropriately designing the compositions, the thicknesses, and other properties of the two surface layers, the curling as might occur in the olefinic resin film itself or in a punched in-mold label can be confined within a certain range.

### [Forming of Olefinic Resin Film]

The olefinic resin film may be produced by using a variety of methods known in the art either alone or in combination, and the forming method is not particularly limited. Olefinic resin films produced by any of such methods fall within the scope of the present invention, provided that the films do not depart from the gist of the present invention.

The olefinic resin film may be produced by forming an olefinic resin-containing film layer by forming techniques, for example, such as cast forming that involve pushing a molten resin into a sheet form through a monolayer or multilayer T die or I die connected to a screw extruder, calender forming, press-roll forming, and inflation forming. Forming of an olefinic resin-containing film layer also may be performed by casting or calendering the olefinic resin after mixing it with an organic solvent or an oil, and removing the solvent or oil.

### [Lamination]

The olefinic resin film may have a monolayer structure, or a multilayer structure of two or more layers. Lamination provides various functions to the olefinic resin film, such as improved mechanical properties, writability, abrasion resistance, and suitability to secondary processing.

Various known methods may be used to form an olefinic resin film of a multilayer structure. Specific examples include dry lamination, wet lamination, and melt lamination using various adhesives, multilayer dicing (coextrusion) using a feed block or a multi-manifold, extrusion lamination using a plurality of dices, and coating using various coaters. Multilayer dicing and extrusion lamination may be used in combination.

### [Stretching]

The olefinic resin film may be an unstretched film or a stretched film. The olefinic resin film may be stretched by using any of the various common methods either alone or in combination, and the method is not particularly limited. For example, the olefinic resin melt kneaded with a screw extruder, and formed into a sheet form by extrusion through a T or I die connected to the extruder may be stretched to obtain the resin film. In this case, methods such as roller machine stretching that utilizes the circumferential velocity differences between a group of rollers, transverse stretching that uses a tenter oven, and serial biaxial stretching that uses these two techniques in combination may be used. It is also possible to use press rolling that uses roller pressure, simultaneous biaxial stretching that uses a tenter oven and a pantograph in combination, and simultaneous biaxial stretching that uses a tenter oven and a linear motor in combination. Another example is simultaneous biaxial stretching (inflation forming) that blows air into a molten resin that has been extrusion molded into a tubular form through a circular die connected to a screw extruder.

When the olefinic resin film is configured from a plurality of layers, it is preferable that at least one of the layers is stretched in at least one direction. A stretched olefinic resin film has high mechanical strength and excellent thickness uniformity, and can produce in-mold labels that are suited for post-processes such as printing. When the olefinic resin film has a multilayer structure, the number of stretch axes in each layer forming the film may be 1 axis/1 axis, 1 axis/2 axes, 2 axes/1 axis, 1 axis/1 axis/2 axes, 1 axis/2 axes/1 axis, 2 axes/1 axis/1 axis, 1 axis/2 axes/2 axes, 2 axes/2 axes/1 axis, or 2 axes/2 axes/2 axes. When stretching a plurality of layers, the layers may be individually stretched before laminating the layers, or may be stretched together after being laminated. It is also possible to stretch a laminate of stretched layers.

Preferably, the olefinic resin film is stretched within a temperature range that is suited for the olefinic resin contained in the film. Specifically, when the olefinic resin used in the film is an amorphous resin, the stretch temperature is preferably equal to or greater than the glass transition point of the olefinic resin. When the olefinic resin used in the film is a crystalline resin, the stretch temperature is preferably between the glass transition point of the amorphous portion of the olefinic resin and the melting point of the crystalline portion of the olefinic resin. Specifically, the film stretch temperature is preferably 1 to 70° C. lower than the melting point of the olefinic resin used in the film. For example, the film stretch temperature is preferably 100 to 166° C. when the olefinic resin used in the film is a homopolymer of propylene (melting point of 155 to 167° C.), and 70 to 135° C. when the olefinic resin is a high-density polyethylene (melting point of 121 to 136° C.)

When stretching the olefinic resin film, the stretch rate is not particularly limited, and is preferably 20 to 350 m/min for stable stretching and forming of the olefinic resin film. The stretch ratio of stretching the olefinic resin film is appropriately decided taking into consideration factors such as the properties of the olefinic resin used in the film. For example, when the olefinic resin used in the film is a homopolymer of propylene or a copolymer thereof, the stretch ratio for the unidirectional stretch of the film is typically about 1.5 to 12, preferably 2 to 10. For biaxial stretching, the stretch ratio is typically 1.5 to 60, preferably 4 to 50 in terms of an area stretch ratio. In these ranges, it becomes easier to obtain desirable voids, and to improve opacity. The olefinic resin film also becomes unlikely to break, and tends to enable stable stretching and forming.

### [Void Formation]

Fine voids can form inside the film when the olefinic resin film is a stretched film that contains at least one of inorganic fine powder and organic filler. Void formation enables forming a lighter olefinic resin film, and improving film properties such as flexibility and opacity.

The proportion of voids in the film can be represented by porosity. From the viewpoint of obtaining lightness and opacity, the porosity of the olefinic resin film is preferably 10% or more, more preferably 15% or more, further preferably 20% or more. On the other hand, from the viewpoint of maintaining mechanical strength, the porosity of the olefinic resin film is preferably 50% or less, more preferably 45% or less, further preferably 40% or less.

The porosity of the olefinic resin film may be measured as a proportion of the area occupied by voids in a cross sectional region of the olefinic resin film observed under an electron microscope. Specifically, the porosity of the olefinic resin film may be determined as follows. An arbitrary portion of a resin film sample is cut out, and embedded in epoxy resin to solidify. The film is then cut in a direction perpendicular to the film plane by using a microtome, the slice is attached to an observation sample holder to enable observation of the cross section. Thereafter, gold or gold-palladium is vapor deposited on the surface to be observed, and surface voids are observed with an electron microscope at a desired magnification (for example, 500 to 3000 times). The observed region is captured as image data, and the image is processed by an image analyzer to find the percentage area of the void portion as porosity. Here, the porosity may be an average of the measured values taken at 10 or more arbitrary observation points.

### [Thickness]

The olefinic resin film has a thickness of preferably 30 μm or more, more preferably 40 μm or more, further preferably 50 μm or more. With a thickness of 20 μm or more, the olefinic resin film can provide sufficient stiffness to the in-mold label, and is unlikely to cause trouble during printing or insertion into a mold. The olefinic resin film has a thickness of preferably 200 μm or less, more preferably 175 μm or less, further preferably 150 μm or less. With a thickness of 200 μm or less, the olefinic resin film does not become overly stiff, and makes it easier for the label to conform to the shape of the plastic container during molding.

### [Density]

The olefinic resin film has a density or preferably 0.6 g/cm³ or more, more preferably 0.65 g/cm³ or more, further preferably 0.7 g/cm³ or more. With a density of 0.6 g/cm³ or more, the olefinic resin film can provide sufficient stiffness to the in-mold label, and is unlikely to cause trouble during printing or insertion into a mold. The olefinic resin film has a density of preferably 0.95 g/cm³ or less, more preferably 0.9 g/cm³ or less, further preferably 0.85 g/cm³ or less. With a density of 0.95 g/cm³ or less, the olefinic resin film can have lightness, and makes the in-mold label easy to handle. Preferably, the olefinic resin film has these densities achieved by internal voids.

### [Heat Sealing Layer]

The heat sealing layer contains a thermoplastic resin, and serves as an adhesive for bonding the in-mold label to a plastic container. The following describes the composition, the configuration, and the producing process of the heat sealing layer.

### [Thermoplastic Resin]

The thermoplastic resin used for the heat sealing layer has the following characteristics (1) and (2).

(1) At least one crystallization peak occurs between 85 to 110° C. in differential scanning calorimetry.

(2) The hot tack force at 130° C. is 120 to 350 gf/cm².

### [Composition]

Examples of such heat sealing thermoplastic resins include ethylene-based resins with melting points of 80 to 138° C., such as high-density polyethylene, medium-density polyethylene, low-density polyethylene, linear low-density polyethylene, ethylene-vinyl acetate copolymer, ethylene-(meth)acrylic acid copolymer, ethylene-(meth)alkyl acrylate copolymer (the alkyl group has 1 to 8 carbon atoms), metal salts of ethylene-(meth)acrylic acid copolymer (Zn, Al, Li, K, Na), and ethylene-based copolymers copolymerized with a metallocene catalyst.

Other examples of the heat sealing thermoplastic resins include α-olefin random copolymers or block copolymers obtained by copolymerizing two or more comonomers selected from α-olefins having 2 to 20 carbon atoms within the molecule. Examples of α-olefins having 2 to 20 carbon atoms include ethylene, propylene, 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 4-methyl-1-hexene, 4,4-dimethyl-1-pentene, 3,3-dimethyl-1-butene, 1-heptene, methyl-1-hexene, dimethyl-1-pentene, ethyl-1-pentene, trimethyl-1-butene, methylethyl-1-butene, 1-octene, 1-heptene, methyl-1-pentene, ethyl-1-hexene, dimethyl-1-hexene, propyl-1-heptene, methylethyl-1-heptene, trimethyl-1-pentene, propyl-1-pentene, diethyl-1-butene, 1-nonene, 1-decene, 1-undecene, 1-dodecene, and octadecene. Preferred for ease of copolymerization and economy are ethylene, propylene, 1-butene, 1-pentene, 1-hexene, and 1-octene.

Preferred as thermoplastic resins that can more easily achieve the foregoing characteristics (1) and (2) are, for example, ethylene-propylene random copolymer, ethylene-1-butene random copolymer, ethylene-propylene-1-butene random copolymer, ethylene-1-hexene random copolymer, ethylene-propylene-1-hexene random copolymer, ethylene-1-octene random copolymer, propylene-1-butene random copolymer, and propylene-1-hexene random copolymer. Particularly preferred are ethylene-1-hexene random copolymer, propylene-1-butene random copolymer, and ethylene-propylene-1-butene random copolymer.

### [Configuration]

In the case of a random copolymer of ethylene and α-olefin, the comonomer content in the random copolymer is preferably 40 weight % or more, more preferably 50 weight % or more, particularly preferably 70 weight % or more, and is preferably 98 weight % or less, more preferably 95 weight % or less, particularly preferably 93 weight % or less for ethylene. The α-olefin content is preferably 2 weight % or more, more preferably 5 weight % or more, particularly preferably 7 weight % or more, and is preferably 60 weight % or less, more preferably 50 weight % or less, particularly preferably 30 weight % or less.

In the case of a random copolymer of propylene and α-olefin, the propylene content is preferably 75 mol % or more, more preferably 80 mol % or more, and is preferably 88.5 mol % or less, more preferably 86 mol % or less. The α-olefin content is preferably 11.5 mol % or more, more preferably 14 mol % or more, and is preferably 25 mol % or less, more preferably 20 mol % or less.

In the case of a random copolymer of propylene, ethylene, and α-olefin, the propylene content is preferably 65 mol % or more, more preferably 74 mol % or more, particularly preferably 77 mol % or more, and is preferably 98 mol % or less, more preferably 93.5 mol % or less, particularly preferably 92 mol % or less. The total content of ethylene and α-olefin is preferably 2 mol % or more, further preferably 6.5 mol % or more, particularly preferably 8 mol % or more, and is preferably 35 mol % or less, further preferably 26 mol % or less, particularly preferably 23 mol % or less.

### [Producing Process]

The thermoplastic resin is preferably an ethylene-α-olefin copolymer that is copolymerized with a metallocene catalyst, in order to more readily achieve the foregoing characteristics (1) and (2).

A thermoplastic resin of the desired characteristics can easily be obtained when the copolymer is obtained through copolymerization of the comonomer components with a metallocene catalyst, particularly a metallocene-almoxane catalyst, or, for example, a catalyst that comprises a metallocene compound such as those disclosed in WO92/01723, and a compound that reacts with the metallocene compound to form a stable anion.

It is particularly preferable for ease of achieving the foregoing characteristics (1) and (2) that the thermoplastic resin is an ethylene-1-hexene copolymer that is copolymerized with a metallocene catalyst using a vapor phase method. An ethylene-α-olefin copolymer copolymerized with a metallocene catalyst using a vapor phase method has higher density than conventional metallocene-catalyzed ethylene-α-olefin copolymers copolymerized by using a solution method with a slurry in the manner described in JP-A-9-207166 and other literature. This makes it easier to achieve the high crystallization peak temperature characteristic (1), and to provide the hot tack characteristic (2) by virtue of the wide molecular weight distribution. Such a copolymer is thus more desirable to construct the heat sealing layer intended to solve the problems to be solved by the present invention. When copolymerized with a metallocene catalyst, the thermoplastic resin contains only small amounts of low-molecular components that cause stickiness, and problems such as blocking of the in-mold label are unlikely to occur.

### [Characteristics]

The thermoplastic resin obtained in the manner described above has such a characteristic that (1) at least one crystallization peak occurs between 85 to 110° C. in differential scanning calorimetry. At least one crystallization peak occurs at preferably 87° C. or more, more preferably 89° C. or more. At least one crystallization peak occurs at preferably 105° C. or less, more preferably 100° C. or less. Such high crystallization peak temperatures are not observed in the low-melting-point heat sealing thermoplastic resins of related art. With the thermoplastic resin having a crystallization peak in these temperature ranges, a plastic container after high-temperature discharge becomes naturally cooled in the atmosphere, and the crystallization of the heat sealing layer in the in-mold label quickly ends in the process of dimensional changes of the container. The bonding between the in-mold label and the plastic container can also end in a short time period. This enables reducing defects such as peeling and blisters when the plastic container undergoes dimensional changes before the label becomes bonded under the high-temperature discharge condition.

The thermoplastic resin has such a characteristic that (2) the hot tack force at 130° C. is 120 to 350 gf/cm². The hot tack force is preferably 140 gf/cm² or more, further preferably 160 gf/cm² or more, and is preferably 340 gf/cm² or less, further preferably 330 gf/cm² or less. With a hot tack force higher than 120 gf/cm² at the foregoing temperature, the thermoplastic resin can provide a cohesive force (tack force), and the label can remain fixed to the plastic container while the thermoplastic resin is being naturally cooled and solidified to completely bond the plastic container, even when the plastic container is discharged under high temperature and the thermoplastic resin is in a molten state. This enables reducing defects such as blisters. The present invention was completed on the basis of this finding. The hot tack force does not cause a problem in performance even when it exceeds 350 gf/cm². However, a thermoplastic resin with such a high hot tack force is not readily available. The hot tack force is easily obtained when the thermoplastic resin has a wide molecular weight distribution with a large proportion of branched chains in the molecular structure. However, because an excessively wide molecular weight distribution tends to cause stickiness due to low-molecular components, it is preferable to use the thermoplastic resin after appropriately adjusting the molecular weight distribution by varying conditions such as the resin polymerization conditions.

The thermoplastic resin preferably has at least one melting peak between 90 and 130° C. in differential scanning calorimetry. At least one melting peak occurs at more preferably 95° C. or more, further preferably 100° C. or more, and more preferably 128° C. or less, further preferably 127° C. or less. The thermoplastic resin becomes more suitable for heat sealing when it has a melting peak in these temperature ranges.

The thermoplastic resin has a density of preferably 0.905 to 0.940 g/cm³. The density is more preferably 0.910 g/cm³ or more, further preferably 0.911 g/cm³ or more, and is more preferably 0.939 g/cm³ or less, further preferably 0.929 g/cm³ or less. The density of the thermoplastic resin is a parameter associated with the proportion of branched chains in the molecular structure of the thermoplastic resin. The thermoplastic resin becomes more suitable for heat sealing and high-temperature discharge when its density falls in the foregoing ranges.

Any known resin additives may be added to the heat sealing layer of the present invention, provided that such addition does not inhibit the desired performance. Examples of such additives include dyes, nucleating agents, plasticizers, release agents, antioxidants, fire retardants, and UV absorbers.

### [Production of In-Mold Label]

### [Lamination]

The heat sealing layer containing the thermoplastic resin may be deposited and laminated on one surface of the olefinic resin film by using methods such as coating, coextrusion, melt extrusion lamination, heat lamination of a resin composition film, and dry lamination of a resin composition film.

The heat sealing layer may be laminated on the olefinic resin film while forming the olefinic resin film on the same forming line, or on a different line after forming the olefinic resin film.

### [Thickness]

The thickness of the heat sealing layer is preferably 0.5 to 20 μm, more preferably 1 to 10 μm. A thickness of 0.5 μm or more is preferable because it allows the heat sealing layer to maintain a uniform thickness, and improves the strength of the bonding between the label and the plastic container. A thickness of 20 μm or less is preferable because it makes the in-mold label unlikely to curl, and makes it easier to fix the label to the mold.

### [Processing of In-Mold Label]

### [Embossing]

Preferably, the heat sealing layer of the in-mold label is embossed to further reduce blisters, as described in JP-A-2-84319 and JP-A-3-260689. As an example, the embossed pattern may have a line density of 20 to 1500/2.54 cm. The emboss height may range from, for example, 1 to 30 μm in terms of a ten point height of irregularities (Rz) as measured by using the method described in JIS-B-0601. Preferably, embossing rolls with the selected numbers of lines or depth are used to achieve such a line density or a height.

### [Printing]

The in-mold label may be subjected to a surface treatment such as corona discharge to improve printability and bondability, as required. Printing may be performed by using techniques such as gravure printing, offset printing, flexography, letter press printing, and screen printing. The in-mold label may be printed with information such as barcode, manufacturer, distributor, characters, product name, and usage and the like.

### [Punching]

The printed in-mold label may be punched into separate shapes of the required dimensions. The in-mold label may be attached to the whole surface of a plastic container, or to a part of the container surface. For example, the in-mold label may be used as a blank by being wrapped around side surfaces of a plastic container that is produced by being injection molded into a form of a cup, or as a label attached to the front and back surfaces of a plastic container that is produced by being blow molded into a form of a bottle.

### [In-Molding]

A labeled plastic container may be obtained by in-mold labeling, using any of blow molding, injection molding, and differential pressure molding. The in-mold label of the present invention is adapted for use with any of the foregoing molding methods.

For example, in blow molding, the in-mold label is positioned inside the cavity of at least one mold with the heat sealing layer facing the cavity (the printed side is in contact with the mold), and fixed to the inner wall of the mold by means of suction or static electricity. A parison or a preform melt of a resin used as the container material is then guided into the mold, and blow molded by using an ordinary method after clamping the mold. This produces a labeled plastic container with the label integrally fused into the outer wall of the plastic container.

In injection molding, for example, the in-mold label is positioned inside the cavity of a female mold with the heat sealing layer facing the cavity (the printed side is in contact with the mold), and fixed to the inner wall of the mold by means of suction or static electricity. After clamping the mold, a melt of a resin used as the container material is injected into the mold. This produces a labeled plastic container with the label integrally fused into the outer wall of the plastic container.

In differential pressure molding, for example, the in-mold label is installed inside the cavity of the lower female mold of a differential pressure mold with the heat sealing layer facing the cavity (the printed side is in contact with the mold), and fixed to the inner wall of the mold by means of suction or static electricity. A melt of a resin sheet used as the container material is then guided to above the lower female mold, and differential pressure molded by using an ordinary method. This produces a labeled plastic container with the label integrally fused into the outer wall of the plastic container. The differential pressure molding may be vacuum molding or compression molding. Typically, it is preferable to use plug-assisted differential pressure molding that combines vacuum molding and compression molding.

The in-mold label of the present invention is particularly useful for blow molding and injection molding, which involve the risk of the plastic container being discharged from the mold in a high temperature state.

### [Labeled Plastic Container]

The labeled plastic containers obtained by using the foregoing techniques involve fewer defects due to label detachment or label deformation such as blisters.

Preferably, the label is not easily detachable from the labeled plastic container. Specifically, the label bonding strength against the plastic container as measured by using the method described below is preferably 200 gf/15 mm or more, more preferably 300 gf/15 mm or more, further preferably 400 gf/15 mm or more. With a label bonding strength of 200 gf/15 mm or more, the label does not become easily detached from the plastic container during use. On the other hand, the label bonding strength is preferably 1500 gf/15 mm or less, more preferably 1200 gf/15 mm or less, further preferably 1000 gf/15 mm or less. The label bonding strength should be as high as possible; however, a label bonding strength in excess of 1500 gf/15 mm is not easily obtainable.

### [Suitability of Labeled Plastic Container to Loading of High-Temperature Contents]

The labeled plastic container obtained in the present invention is highly suitable to loading of high-temperature contents.

A problem of conventional in-mold labeled plastic containers is that the thermoplastic resin in the heat sealing layer melts when it has a low melting point (melting peak temperature), and the in-mold label detaches itself upon loading the in-mold labeled plastic container with high-temperature contents, or upon heat sterilizing the container contents at high temperature.

However, when the thermoplastic resin used in the heat sealing layer of the in-mold label has a melting point (melting peak temperature) equal to or greater than the specific temperature as in the present invention, it is possible to provide a plastic container from which a label does not become detached even when the container is loaded with high-temperature contents.

### EXAMPLES

The following more specifically describes features of the present invention by using Examples and Comparative Examples.

The various conditions used in Examples and Comparative Examples, including materials, amounts, proportions, and the processing contents and procedures may be appropriately varied within the gist of the present invention. The following specific examples thus should not be construed as being limiting the scope of the present invention. The raw materials used for the production of in-mold labels in Examples and Comparative Examples are presented in Table 1.

TABLE 1

| Type | Code | Contents |
|---|---|---|
| Olefinic | PP1 | Propylene homopolymer (Novatec PP MA4, Japan Polypropylene, MFR (JIS-K7210) = 5 g/10 min, |
| resin | | melting peak temperature (JIS-K7121) = 167° C. |
| Thermo- | PE1 | Ethylene-based resin polymerized with metallocene catalyst (Harmolex NH745N, Japan Polyethylene, |
| plastic | | MFR (JIS-K7210) = 8 g/10 min, melting peak temperature (JIS-K7121) = 121° C., |
| resin | | Crystallization peak temperature (JIS-K7121) = 97° C., density = 0.913 g/cm³) |
| | PE2 | Ethylene-based resin polymerized with metallocene catalyst (Harmolex NJ744N, Japan Polyethylene, |
| | | MFR (JIS-K7210) = 12 g/10 min, melting peak temperature (JIS-K7121) = 120° C., |
| | | Crystallization peak temperature (JIS-K7121) = 95° C., density = 0.911 g/cm³) |
| | PE3 | Ethylene-based resin polymerized with metallocene catalyst (Evolue SP1540, Prime Polymer, |
| | | MFR (JIS-K7210) = 3.8 g/10 min, melting peak temperature (JIS-K7121) = 113° C., |
| | | Crystallization peak temperature (JIS-K7121) = 93° C., density = 0.913 g/cm³) |
| | PE4 | Ethylene-based resin polymerized with metallocene catalyst (Evolue SP4030, Prime Polymer, |
| | | MFR (JIS-K7210) = 3.8 g/10 min, melting peak temperature (JIS-K7121) = 127° C., |
| | | Crystallization peak temperature (JIS-K7121) = 99° C., density = 0.938 g/cm³) |
| | PE5 | Ethylene-based resin polymerized with metallocene catalyst (Kernel KC580S, Japan Polyethylene, |
| | | MFR (JIS-K7210) = 10.5 g/10 min, melting peak temperature (JIS-K7121) = 109° C., |
| | | Crystallization peak temperature (JIS-K7121) = 92° C., density = 0.920 g/cm³) |
| | PE6 | Ethylene-based resin polymerized with metallocene catalyst (Kernel KS571, Japan Polyethylene, |
| | | MFR (JIS-K7210) = 12 g/10 min, melting peak temperature (JIS-K7121) = 100° C., |
| | | Crystallization peak temperature (JIS-K7121) = 89° C., density = 0.907 g/cm³) |
| | PE7 | Ethylene-based resin polymerized with metallocene catalyst (Kernel KC452T, Japan Polyethylene, |
| | | MFR (JIS-K7210) = 6.5 g/10 min, melting peak temperature (JIS-K7121) = 55° C., |
| | | Crystallization peak temperature (JIS-K7121) = 53° C., density = 0.888 g/cm³) |
| | PE8 | Low-Density polyethylene (Novatec LD LC602A), Japan Polyethylene, |
| | | MFR (JIS-K7210) = 8.2 g/10 min, melting peak temperature (JIS-K7121) = 107° C., |
| | | Crystallization peak temperature (JIS-K7121) = 93° C., density = 0.919 g/cm³) |
| | PE9 | Low-Density polyethylene (Novatec HD HJ360), Japan Polyethylene, |
| | | MFR (JIS-K7210) = 5.5 g/10 min, melting peak temperature (JIS-K7121) = 132° C., |
| | | Crystallization peak temperature (JIS-K7121) = 113° C., density = 0.951 g/cm³) |
| Inorganic | CA1 | Heavy calcium carbonate (Softon #1800, Bihoku Funka Kogyo, average particle size = 1.8 μm) |
| fine powder | CA2 | Surface-treated precipitated calcium carbonate (MSK-PO, Maruo Calcium, average particle size = 0.15 μm, fatty acid |
| | | treated) |
| | TIO | Rutile-type titanium dioxide (Taipaque CR-60, Ishihara Sangyo Kaisha, average particle size = 0.2 μm) |

### Examples 1 to 7, and Comparative Examples 1 to 4

The materials presented in Table 1 were mixed in the proportions shown in Table 2 to obtain olefinic resins. Each resin was melt kneaded with an extruder at 250° C., fed to a T die at 250° C., extruded into a sheet form, and cooled to about 60° C. with cool rolls to obtain an unstretched sheet. The unstretched sheet was then reheated to the machine stretch temperature shown in Table 2, and stretched in machine direction at the ratios shown in Table 2 by using the circumferential velocity differences between a group of rollers. The sheet was then cooled to about 60° C. to obtain a stretched sheet.

The thermoplastic resins shown in Table 2 were each melt kneaded with an extruder at 230° C., and extruded into a sheet form with a T die at 230° C. The thermoplastic resin and the stretched sheet were guided between a gravure embossed metallic cool roll (#150 line) and a matte rubber roll, and bonded to each other under the roller pressure to transfer the emboss pattern to the thermoplastic resin side. The sheet was then cooled with cool rolls to obtain a laminated resin sheet of an olefinic resin film/heat sealing layer bilayer structure.

Thereafter, the laminated resin sheet was reheated with a tenter oven to the transverse stretch temperature shown in Table 2, and stretched in transverse direction with a tenter at the ratio shown in Table 2. The sheet was annealed in a heat setting zone that had been brought to 160° C., and cooled to about 60° C. with cool rolls. A biaxially stretched resin film of a bilayer structure with the thickness, the density, and the inorganic fine powder content shown in Table 2 was then obtained as an in-mold label upon slitting the edge of the sheet.

The film was guided into a corona discharge device with guide rolls, and the surface on the olefinic resin film side was subjected to a corona discharge process at 50 W·min/m². The processed film was then reeled into a winder.

The laminated resin sheet of Comparative Example 4 became unstable, and frequently broke during the transverse stretch with a tenter, and failed to form a biaxially stretched resin film.

### Examples 8 and 10

PP1, CA1, and TIO presented in Table 1 were mixed in the proportions shown in Table 2 to obtain olefinic resins. Each resin was melt kneaded with an extruder at 250° C., fed to a T die at 250° C., extruded into a sheet form, and cooled to about 60° C. with cool rolls to obtain an unstretched sheet. The unstretched sheet was then reheated to the machine stretch temperature shown in Table 2, and stretched in machine direction at the ratios shown in Table 2 by using the circumferential velocity differences between a group of rollers. The sheet was then cooled to about 60° C. to obtain a stretched sheet.

PE2 shown in Table 1 was melt kneaded with an extruder at 230° C., and extruded into a sheet form with a T die at 230° C. The thermoplastic resin and the stretched sheet were guided between a gravure embossed metallic cool roll (#400 line) and a matte rubber roll, and bonded to each other under the roller pressure while transferring the emboss pattern to the thermoplastic resin side. The sheet was cooled, and a uniaxially stretched resin film of an olefinic resin film/heat sealing layer bilayer structure with the thickness, the density, and the inorganic fine powder content shown in Table 2 was obtained as an in-mold label upon slitting the edge of the sheet.

The film was guided into a corona discharge device with guide rolls, and the surface on the olefinic resin film side was subjected to a corona discharge process at 50 W·min/m². The processed film was then reeled into a winder.

### Example 9

An olefinic resin as a mixture of PP1 (95 weight %) and TIO (5 weight %) shown in Table 1, and PE2 shown in Table 1 were separately melt kneaded with two extruders at 250° C. These were fed to the same coextrusion die at 250° C., and extruded into a sheet form after being laminated within the die. The sheet was then guided between a semi-mirror surface cool roll and a matte rubber roll, and cooled under the roller pressure. As a result, an unstretched resin film of an olefinic resin film/heat sealing layer bilayer structure with the thickness, the density, and the inorganic fine powder content shown in Table 2 was obtained as an in-mold label.

The film was guided into a corona discharge device with guide rolls, and the surface on the olefinic resin film side was subjected to a corona discharge process at 50 W·min/m². The processed film was then reeled into a winder.

A hard chromium plated, mirror finished (planarized) metallic cool roll was used as the semi-mirror surface cool roll after being processed to have a semi-mirror surface and polished. The semi-mirror surface cool roll had a diameter of 450 mm and a width of 1500 mm with a surface roughness (arithmetic mean roughness Ra according to JIS B-0601) of 0.3 μm, a maximum height (Ry) of 2.9 μm, and a ten point height of irregularities (Rz) of 2.2 μm. The cooling temperature was 70° C.

The matte rubber roll had a diameter of 300 mm and a width of 1500 mm, and had a rubber hardness (JIS K-6301: 1995) of 70 Hs as measured with a spring-loaded JIS hardness meter. The matte rubber roll contained 20 to 55 weight % of silica sand and silicate glass fine particles, which had a particle size of 31 to 37 μm.

The film was molded under the pressure of the semi-mirror surface cool roll in contact with thermoplastic resin side and the matte rubber roll in contact with the olefinic resin side.

### Evaluation Examples

### Thickness

The thickness of the in-mold label of the present invention was measured in the manner described in JIS-K-7130, using a Constant Pressured Thickness Measuring Instrument (Teclock, Model: PG-01J).

For the thickness measurements of the olefinic resin film and the heat sealing layer forming the in-mold label, a sample to be measured was cooled to −60° C. or less with liquid nitrogen, and was vertically cut on a glass plate with a razor blade (Schick Japan, Proline Blade) to prepare a sample for cross section measurement. The sample cross section was then observed with a scanning electron microscope (JEOL, Model: JSM-6490). The boundary line for each thermoplastic resin composition was distinguished by observing the composition appearance, and the total thickness and the proportions of the observed layer thicknesses were determined by multiplication. The results are presented in Table 2.

### (Basis Weight)

The basis weight of the in-mold label of the present invention was measured with an electronic balance in the manner described in JIS-P-8124, using a 100 mm×100 mm punched sample.

### (Density)

The density of the in-mold label of the present invention was determined by dividing the basis weight by thickness. The results are presented in Table 2.

The density of the thermoplastic resin was determined according to the A method in JIS-K-7112, using a water displacement method for a pressed sheet of the thermoplastic resin. The results are presented in Table 1.

### (Crystallization Peak Temperature by Differential Scanning Calorimetry)

The crystallization peak temperature of the thermoplastic resin of the present invention is measured in the manner described in JIS-K-7121. Specifically, the thermoplastic resin is completely melted with a differential scanning calorimeter (Model: DSC 6200, Seiko Instruments Inc.), and the major peak temperature that appears upon cooling the resin at a cooling rate of 10° C./min was obtained as crystallization peak temperature. The results are presented in Table 1.

### (Melting Peak Temperature by Differential Scanning Calorimetry)

The crystallization peak temperature of the thermoplastic resin of the present invention is measured in the manner described in JIS-K-7121. Specifically, the major peak temperature that appears upon heating the thermoplastic resin at a heating rate of 10° C./min with a differential scanning calorimeter (Model: DSC 6200, Seiko Instruments Inc.) was obtained as melting peak temperature. The results are presented in Table 1.

### (Hot Tack Force)

In the present invention, hot tack force was measured by using a tacking tester (Model: TAC-II, Rhesca Corporation Limited).

Specifically, an evaluation sample prepared by cutting the in-mold label into a 100 mm×100 mm size is installed in a sample holder that has been brought to a temperature of 30° C., with the heat sealing layer facing up. A probe measuring 30 mm in diameter and brought to 130° C. is then contacted to the surface of the evaluation sample on the heat sealing layer side under a 50-gf load for 60 seconds. The probe is then lifted up at a rate of 120 mm/min, and the resistance experienced by the probe against the adhesion of the thermoplastic resin upon separating the probe from the evaluation sample is obtained as a load value. The maximum load value was taken as hot tack force. The results are presented in Table 2.

TABLE 2

| | Olefinic resin film | | | | | Stretch conditions | | | |
|---|---|---|---|---|---|---|---|---|---|
| | materials and proportions | | | | Thermoplastic | Machine stretch | | Transverse stretch | |
| | PP1 | CA1 | CA2 | TIO | resin | Temperature | Ratio | Temperature | Ratio |
| | (wt %) | (wt %) | (wt %) | (wt %) | Type | (° C.) | (times) | (° C.) | (times) |
| EX. 1 | 89 | 10 | — | 1 | PE1 | 140 | 4 | 160 | 9 |
| EX. 2 | 75 | 24 | — | 1 | PE2 | 150 | 4 | 165 | 9 |
| EX. 3 | 69 | 30 | — | 1 | PE2 | 140 | 5 | 155 | 9 |
| EX. 4 | 61 | 24 | 14 | 1 | PE3 | 140 | 4 | 160 | 9 |
| EX. 5 | 45 | 24 | 30 | 1 | PE4 | 140 | 4 | 165 | 9 |
| EX. 6 | 85 | 14 | — | 1 | PE5 | 145 | 4 | 165 | 9 |
| EX. 7 | 95 | 4 | — | 1 | PE6 | 140 | 4 | 160 | 9 |
| EX. 8 | 75 | 24 | — | 1 | PE2 | 138 | 6 | — | — |
| EX. 9 | 95 | — | — | 5 | PE2 | — | — | — | — |
| EX. 10 | 30 | 69 | | 1 | PE2 | 150 | 4 | — | — |
| Com. | 75 | 24 | — | 1 | PE7 | 145 | 4 | 165 | 9 |
| Ex. 1 | | | | | | | | | |
| Com. | 75 | 24 | — | 1 | PE8 | 140 | 4 | 160 | 9 |
| Ex. 2 | | | | | | | | | |
| Com. | 75 | 24 | — | 1 | PE9 | 145 | 4 | 160 | 9 |
| Ex. 3 | | | | | | | | | |
| Com. | 20 | 80 | — | — | PE9 | 145 | 3 | 160 | 3 |
| Ex. 4 | | | | | | | | | |

| | Properties | | | | | |
|---|---|---|---|---|---|---|
| | | | | | | Hot tack force, |
| | Thickness (μm) | | | Density | Content of inorganic | measured value |
| | Olefinic film | Heat sealing layer | Total label | (g/cm³) | fine powder (wt %) | (gf/cm²) |
| EX. 1 | 106 | 4 | 110 | 0.78 | 11 | 233 |
| EX. 2 | 74 | 6 | 80 | 0.97 | 25 | 255 |
| EX. 3 | 78 | 2 | 80 | 0.55 | 25 | 330 |
| EX. 4 | 127 | 3 | 130 | 0.75 | 39 | 210 |
| EX. 5 | 76 | 4 | 80 | 0.84 | 55 | 168 |
| EX. 6 | 66 | 4 | 70 | 0.88 | 15 | 276 |
| EX. 7 | 81 | 4 | 85 | 0.88 | 5 | 296 |
| EX. 8 | 90 | 5 | 95 | 0.88 | 25 | 290 |
| EX. 9 | 76 | 4 | 80 | 0.95 | 5 | 205 |
| EX. 10 | 98 | 4 | 82 | 0.71 | 70 | 310 |
| Com. | 61 | 4 | 65 | 0.88 | 25 | 130 |
| Ex. 1 | | | | | | |
| Com. | 77 | 3 | 80 | 0.78 | 25 | 83 |
| Ex. 2 | | | | | | |
| Com. | 76 | 4 | 80 | 0.80 | 25 | 53 |
| Ex. 3 | | | | | | |

| | |
|---|---|
| Com. | Undepositable |
| Ex. 4 | |

### (Label Bonding Strength)

The in-mold labels of Examples and Comparative Examples were each punched into a rectangle measuring 60 mm in width and 110 mm in length to prepare a label for production of labeled plastic containers. The label was disposed on one half of a blow molding mold adapted to mold a 400-ml bottle, with the heat sealing layer facing the cavity side, and fixed to the mold by suction air. A high-density polyethylene (Novatec HD HB420R, Japan Polyethylene; MFR (JIS-K7210)=0.2 g/10 min, melting peak temperature (JIS-K7121)=133° C., crystallization peak temperature (JIS-K7121)=115° C., density=0.956 g/cm³) was then melted at 170° C., and extruded into a form of a parison between the molds. After clamping the mold, compressed air of 4.2 kg/cm² was supplied into the parison, and the parison was expanded for 16 seconds into a container shape in contact with the mold, and fused to the label. The molded product was then cooled inside the mold, and removed from the mold to obtain a labeled plastic container. The mold cooling temperature was 20° C., and the shot cycle time was 28 seconds per molding.

The labeled plastic container was stored at 23° C. for 1 week in a 50% relative humidity environment, and the label attached to the labeled plastic container was cut in a shape of a 15 mm-wide strip. The bonding strength between the label and the container was then determined by detaching the label and the container from each other in opposite directions at a rate of 300 mm/min with a tensile tester (Model: Autograph AGS-D, Shimadzu Corporation). The results are presented in Table 3.

### (High-Temperature Discharge)

The in-mold labels of Examples and Comparative Examples were each punched into a rectangle measuring 60 mm in width and 110 mm in length to prepare a label for production of labeled plastic containers. The label was disposed on one half of a blow molding mold adapted to mold a 400-ml bottle, with the heat sealing layer facing the cavity side, and fixed to the mold by suction air. A high-density polyethylene (Novatec HD HB420R, Japan Polyethylene; MFR (JIS-K7210)=0.2 g/10 min, melting peak temperature (JIS-K7121)=133° C., crystallization peak temperature (JIS-K7121)=115° C., density=0.956 g/cm³) was then melted at 170° C., and extruded into a form of a parison between the molds. After clamping the mold, compressed air of 4.2 kg/cm² was supplied into the parison, and the parison was expanded for 8 seconds into a container shape in contact with the mold, and fused to the label. The molded product was then cooled inside the mold, and removed from the mold to obtain a labeled plastic container. The mold cooling temperature was 20° C., and the shot cycle time was 20 seconds per molding to make the thickness of the plastic container 1.8 mm at the labeled portion.

The mold was opened, and the labeled portion of the labeled plastic container was visually observed immediately after discharge from the mold (container discharge temperature: 105° C.). The container was then evaluated according to the following criteria. The results are presented in Table 3.

Excellent: Desirable (desirable external appearance)

Good: Desirable (slightly degraded external appearance, no detachment)

Poor: Defective (Poor external appearance due to blisters or displacement)

TABLE 3

| | In-mold labeled plastic container | |
|---|---|---|
| | Evaluated items | |
| | Label bonding strength, | |
| | measured value | High-temperature discharge |
| | (gf/15 mm) | Visual inspection upon discharge |
| Ex. 1 | 850 | Excellent |
| Ex. 2 | 250 | Excellent |
| Ex. 3 | 560 | Good, Orange peel |
| Ex. 4 | 720 | Excellent |
| Ex. 5 | 415 | Excellent |
| Ex. 6 | 830 | Excellent |
| Ex. 7 | 910 | Good, small blisters |
| Ex. 8 | 910 | Excellent |
| Ex. 9 | 350 | Excellent |
| Ex. 10 | 190 | Excellent |
| Com. Ex. 1 | 600 | Poor, large blisters |
| Com. Ex. 2 | 500 | Poor, large blisters |
| Com. Ex. 3 | 50 | Poor, large blisters |

| | |
|---|---|
| Com. Ex. 4 | No data |

As is clear from Table 3, the labeled plastic containers using the in-mold labels of Examples 1 to 9 had desirable label bonding strengths, and were less likely to be cosmetically defective upon discharge even when produced under short production cycle time and high-temperature discharge conditions to improve productivity. This makes it possible to desirably improve production efficiency.

On the other hand, in the labeled plastic container using the in-mold label of Comparative Example 1 in which the crystallization peak of the thermoplastic resin in the label was less than 85° C., the thermoplastic resin took longer time to crystallize under natural cooling upon high-temperature discharge, and the label formed blisters as it deformed during the crystallization.

In the labeled plastic container using the in-mold label of Comparative Example 2 in which the hot tack force of the thermoplastic resin in the label was less than 120 gf/cm² at 130° C., the cohesive force necessary to hold the label in place on the container during the high-temperature melting of the thermoplastic resin was insufficient, and the label formed blisters as it deformed.

In the labeled plastic container using the in-mold label of Comparative Example 3, the thermoplastic resin in the label had a crystallization peak above 110° C. However, because the hot tack force of the thermoplastic resin in the label was less than 120 gf/cm² at 130° C., the cohesive force necessary to hold the label in place on the container during the high-temperature melting of the thermoplastic resin was insufficient as in Comparative Example 2, and the external appearance was poor as the label bulged out and moved out of position.

As demonstrated above, the in-mold labels of Examples 1 to 9 are more desirable than the in-mold labels of Comparative Examples 1 to 3 that did not satisfy the requirements of the present invention.

1. An in-mold label comprising a heat sealing layer formed on one surface of an olefinic resin film, wherein the heat sealing layer contains a thermoplastic resin having the following characteristics (1) and (2):
(1) at least one crystallization peak occurs between 85 to 110° C. in differential scanning calorimetry,
(2) the hot tack force at 130° C. is 120 to 350 gf/cm².

2. The in-mold label according to claim 1, wherein the thermoplastic resin contained in the heat sealing layer has at least one melting peak between 90 to 130° C. in differential scanning calorimetry.

3. The in-mold label according to claim 1, wherein the thermoplastic resin contained in the heat sealing layer is an ethylene-α-olefin copolymer copolymerized with a metallocene catalyst.

4. The in-mold label according to claim 3, wherein the thermoplastic resin contained in the heat sealing layer is an ethylene-1-hexene copolymer copolymerized with a metallocene catalyst by a vapor phase method.

5. The in-mold label according to claim 1, wherein the thermoplastic resin contained in the heat sealing layer has a density of 0.905 to 0.940 g/cm³.

6. The in-mold label according to claim 1, wherein the olefinic resin film contains an olefinic resin and 1 to 75 weight % of an inorganic fine powder.

7. The in-mold label according to claim 1, wherein the olefinic resin film is stretched in at least one direction.

8. A labeled plastic container comprising the in-mold label of claim 1 attached thereto.
